(19) United States
(12) Patent Application Publication
(10) Pub. No.: US 2012/0043775 A1
(43) Pub. Date: Feb. 23, 2012

(54) Furniture Lifting and Moving Device

(76) Inventor: Juan Martin Villa, Asheboro, NC (US)

(21) Appl. No.: 13/215,687

(22) Filed: Aug. 23, 2011

Related U.S. Application Data
(60) Provisional application No. 61/401,931, filed on Aug. 23, 2010.

(51) Int. Cl. B65G 7/12

(52) U.S. Cl. 294/15

(57) ABSTRACT

A furniture lifting device is made up of a vertically extending rod. A support extension making up a foot extends substantially horizontally from the rod at one end for being received under furniture or objects to be moved to provide a lifting base. A handle is provided at another end of the rod which extends substantially horizontally from the rod in a direction opposite the direction of the support extension.

### CROSS REFERENCE TO RELATED APPLICATIONS

This application is related to U.S. Provisional Application Ser. No. 61/401,931 for Bulky Item Lifting Device filed Aug. 23, 2010, the disclosure of which is specifically incorporated in its entirety by reference herein. Applicant hereby expressly claims priority to the filing date of Aug. 23, 2010 of application Ser. No. 61/401,931.

### FIELD OF THE INVENTION

This invention relates to a device and kit for easily lifting and moving furniture such as sofas and/or other bulky objects. More particularly, the invention relates to such a device and kit which is easily used, is inexpensive to manufacture, and does not place a load on users when employed to lift and move furniture, which may result in physical harm.

### BACKGROUND OF THE INVENTION

Every homeowner has encountered the same problem when faced with moving large items such as sofas, chairs, etc. from one location to another without sliding, which can cause damage to a floor surface. These problems are also encountered with moving such furniture in commercial environments where workers much move large, bulky items such as furniture on a daily basis as part of their employment. One specific problem encountered is that a mover must bend over to grasp a surface to facilitate the lifting action. This action results in a risk of injury, for example, to the lower back.

U.S. Pat. No. 6,478,352 describes an article mover for moving objects and articles such as appliances, boxes, cartons, building materials, construction materials, etc. The device includes a base, a handle and at least one movable handle grip for a user's hands relative to an object to be lifted. However, the device is difficult to use, complicated in construction, and cannot be easily used with a variety of different types of objects to be moved.

Another prior art device described in U.S. Pat. No. 5,294,136 is a one person furniture or appliance mover which is similar to a conventional dolly and is not easily adaptable to move large objects such as sofas.

Accordingly, it is desirable to provide a simple device, easily used by one or two people for lifting and moving large furniture such as sofas or other bulky objects, without hurting a user's back. Moreover, it is also desirable to provide such a device which is compact and easily stored after moving of large furniture or objects has occurred.

In accordance with the invention, the problems involved with the prior art are avoided as further discussed herein.

### SUMMARY OF THE INVENTION

In one aspect, there is provided a furniture or large object lifting device. For purposes of this disclosure and the claims, the term “furniture” is used for convenience, but is intended to encompass furniture as well as other large objects with which the invention can be used. The furniture lifting device includes a vertically extending rod having a support extension or foot which extends substantially horizontally from the rod at one end for being received under furniture to be moved to provide a lifting base for the rod. A handle is provided at another end of the rod extending substantially horizontally from the rod in a direction opposite the direction of the support extension.

In a more specific aspect, the support extension extends at an upward angle of about 10° to about 20° from horizontal. Preferably, the rod, support extension and handle are unitary as a single unit. The lifting device may be made of glass filled polypropylene and the support extension may include a sleeve cover made of thermoplastic polyurethane. In order to ensure a proper lifting motion with the device, the length of the device is such that when in use, the handle reaches to a level slightly below a user's mid-thigh. This allows straightening the back to avoid injury. The support extension is preferably of sufficient length to extend under furniture to be lifted for furniture having an expanded upper dimension greater than the furniture dimension proximate to the floor, such as a sofa having large roll arms.

These and other advantages and features that characterize the invention are set forth in the claims annexed hereto and forming a further part hereof. However, for a further understanding of the invention, and of the advantages and objectives attained from its use, reference should be made to the Drawings and to the accompanying descriptive matter, in which there are described exemplary embodiments of the invention.

### BRIEF DESCRIPTION OF THE DRAWINGS

FIG. 1 is a side view of one embodiment of the lifting device according to the invention.

FIG. 2 is a side view of an alternative embodiment of the lifting device of the invention.

FIG. 3 is a perspective view of the lifting device illustrated in FIG. 2.

FIG. 4 is an enlarged view of the handle portion and a bumper of the lifting device in accordance with the invention.

FIG. 5 is a front view of the bumper section at the handle of the lifting device of the invention.

FIG. 6 is a partial side view illustrating the support extension or foot of the device of the invention, including a sleeve member to provide cushioning and protection to furniture or objects being moved.

FIG. 7 is a partial schematic view illustrating how the lifting device of the invention is positioned for lifting a sofa.

FIG. 8 is a schematic illustration of how two individuals using a kit consisting of four of the lifting devices of the invention can move a large heavy sofa.

### DETAILED DESCRIPTION OF THE INVENTION

In one respect, embodiments consistent with the invention may capitalize on a furniture lifting device which is simple, inexpensive to manufacture and easy to use for moving furniture and a host of other bulky items. Various embodiments of the device can be constructed without departing from the general scope of the specific embodiments described herein.

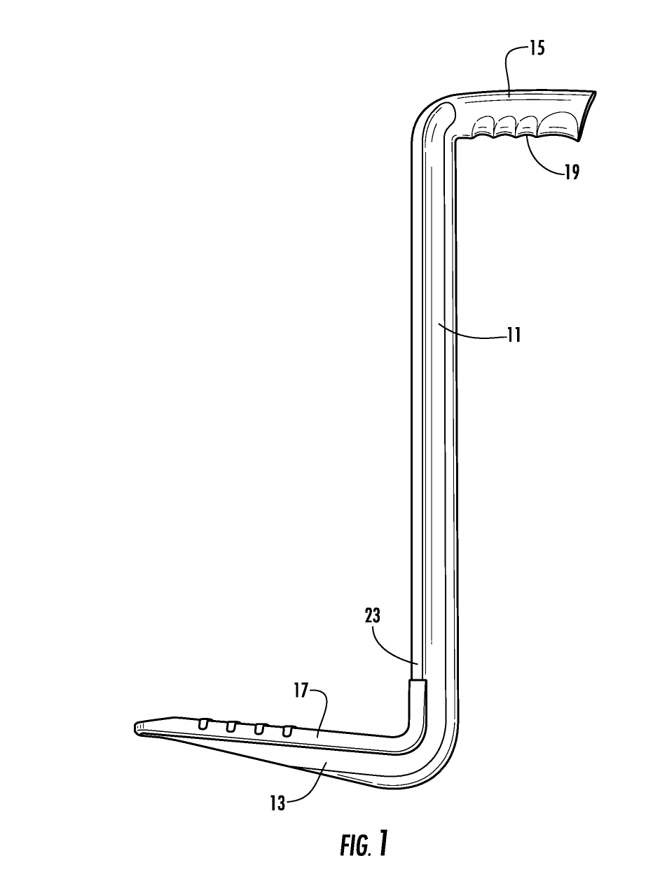

FIG. 1 illustrates a first embodiment of the lifting device 11, having a support extension 13 extending substantially horizontally from a main rod portion, which itself extends vertically, relative to the extension or foot 13. The foot 13 serves to be received under furniture or other bulky devices to be removed. The support extension or foot 13 is of sufficient length to allow it to project underneath an item to be moved when the item has a larger dimension at the top than at the bottom, such as, for example, in the case of sofas having very large roll arms. The lifting device 11 includes a groove 23 to allow sliding of a sleeve 17 which provides cushioning on the top of support extension 13. A handle 15 is provided at the upper end of the device 11 which may include cutouts 19 for accommodating fingers.

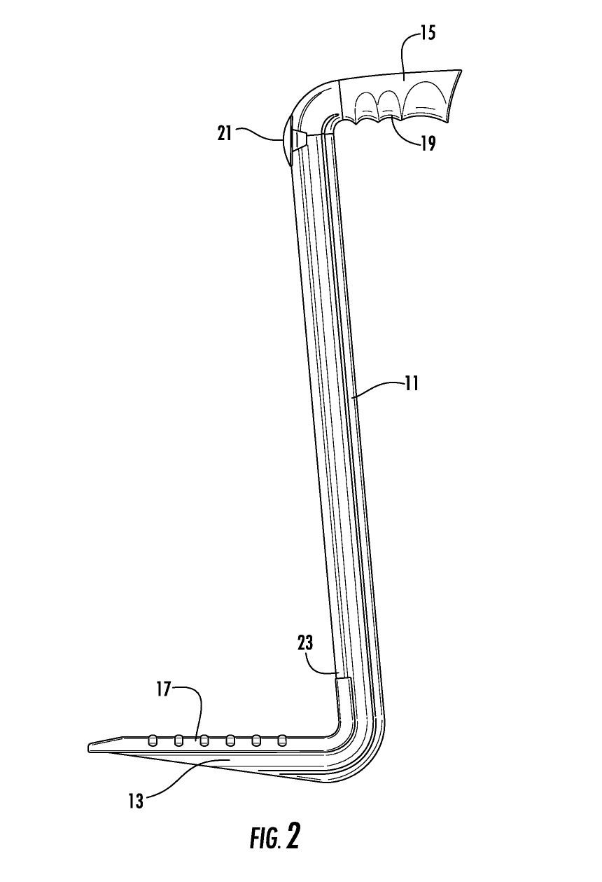

A further embodiment of the device is shown in FIG. 2 which is similar to that of FIG. 1. In the embodiment of FIG. 2 there is provided a bumper 21 of resilient material so that when the device 11 is used in lifting furniture it does not damage an upper end of the furniture or an object being lifted. While the device 11 has been shown to be of unitary single piece construction with the exception of the sleeve 17 in FIG. 1, as may be appreciated from the lines shown in FIG. 2, portions may be assembled together, for example, the handle 15 as well as the bumper 21, through conventional attachment mechanisms or devices. Similarly, a pair of sliding tubes with locking mechanisms can allow lengthening of the device 11 (not shown) in a relatively vertical direction, i.e., along the length of it. Similarly, the support extension 13 can be made up of multiple sliding overlapping members which can lock at different positions relative to each other to allow lengthening or shortening (not shown) at the support extension 13.

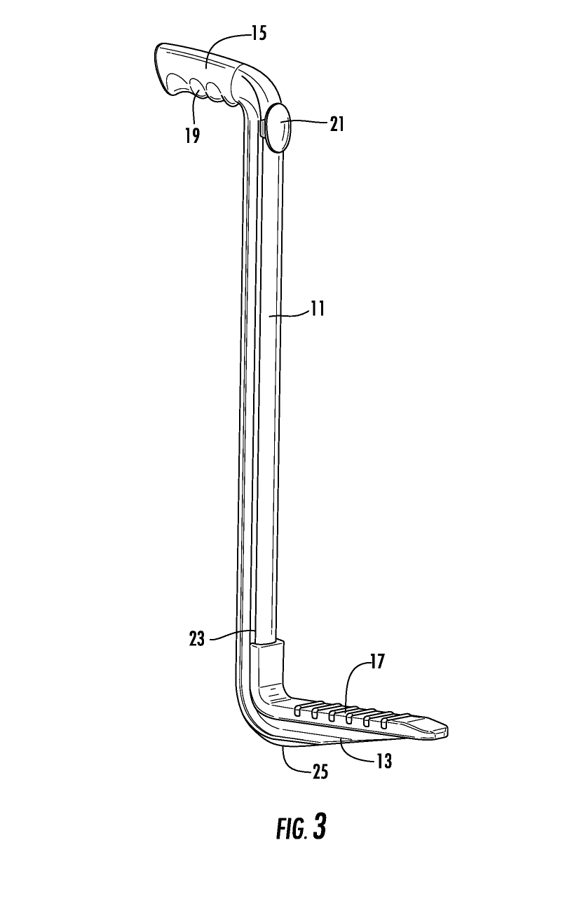

FIG. 3 illustrates in further detail in perspective view, one embodiment of the device 11, which also includes a thicker region 25 at the bottom to provide support for weight placed on the support extension 13 and sleeve 17 to keep it from breaking off. The thicker section provides a rigidifying function.

With respect to materials employed, one embodiment envisions a polypropylene device made through conventional manufacturing technologies. More specifically, a preferred embodiment would use, about 30% glass filled, polypropylene. With respect to the support extension 13 and the sleeve 17, collectively referred to previously at times as the “foot”, the sleeve 17 may be manufactured of a thermoplastic polyurethane. One specific polyurethane is commercially available under the name Bayer Texin TPU 90 Shore A.

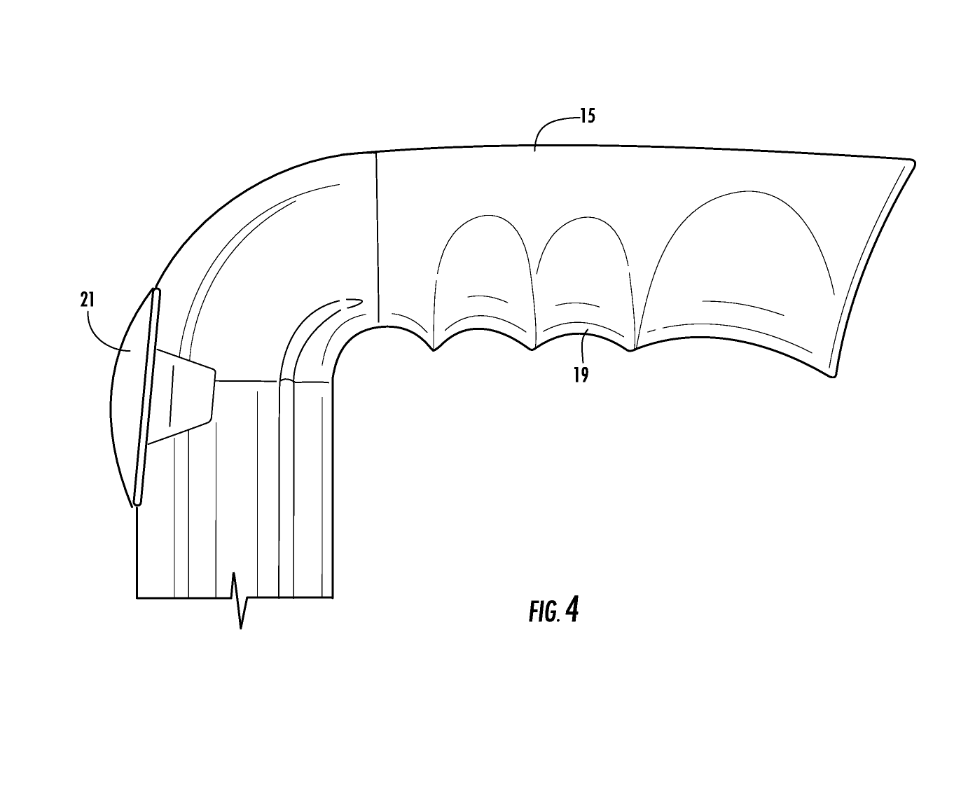

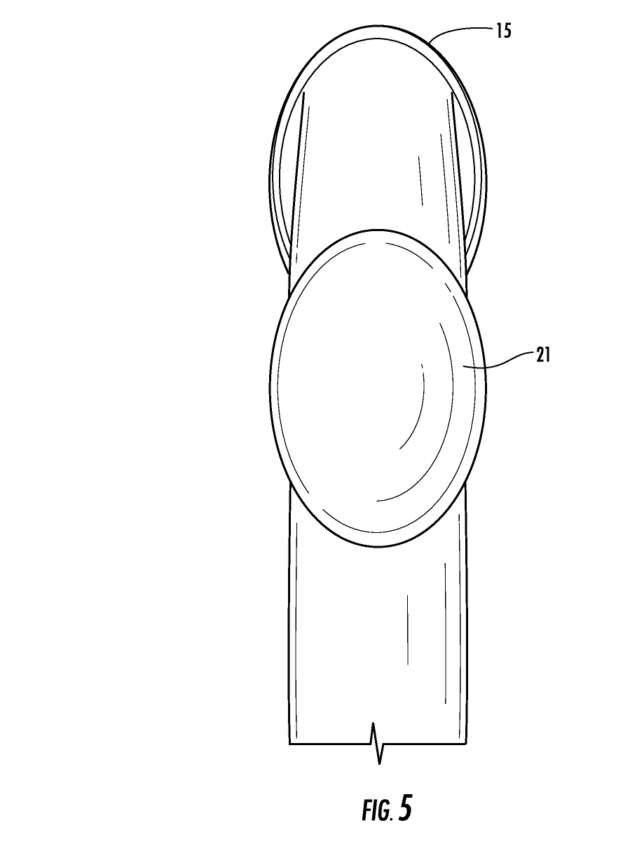

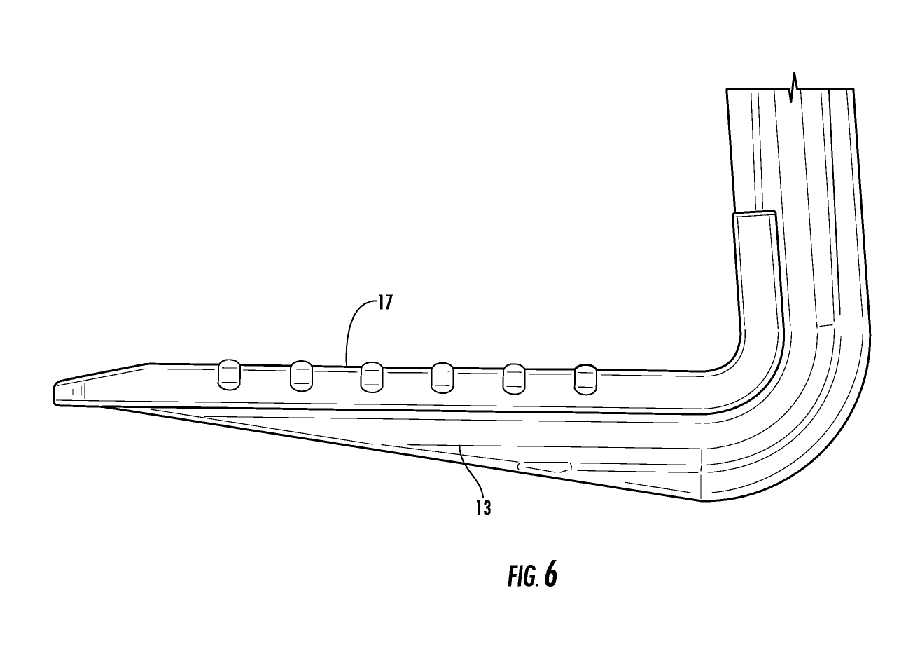

FIGS. 4, 5 and 6 provide greater detail by showing enlarged portions of the device. For example, FIG. 4 shows the handle 15 with cutouts 19 and the bumper 21 at the handle portion. FIG. 5 is a front view of the handle portion showing the bumper 21, and FIG. 6 illustrates in greater detail the foot made up of the support extension 13 and the sleeve 17.

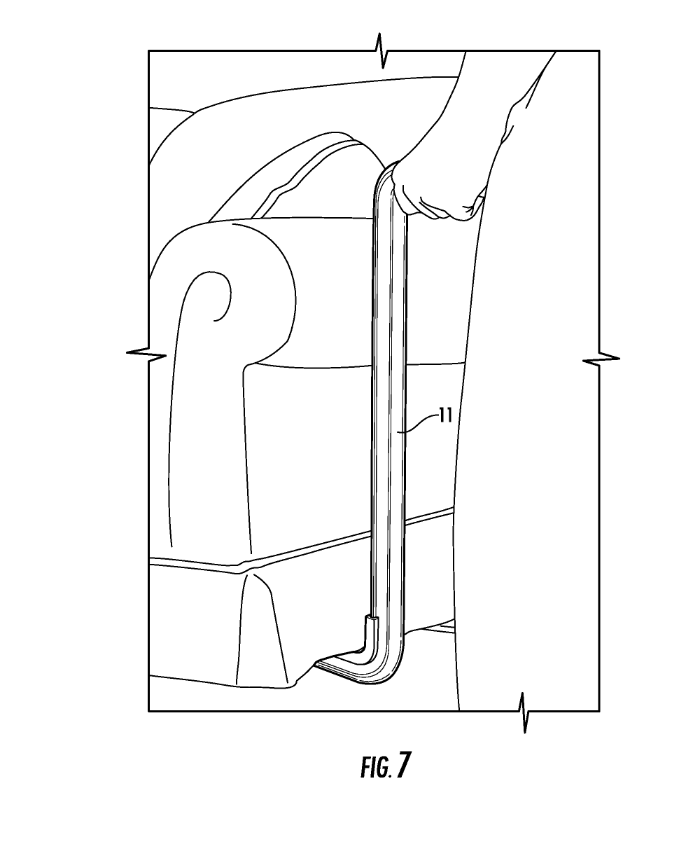

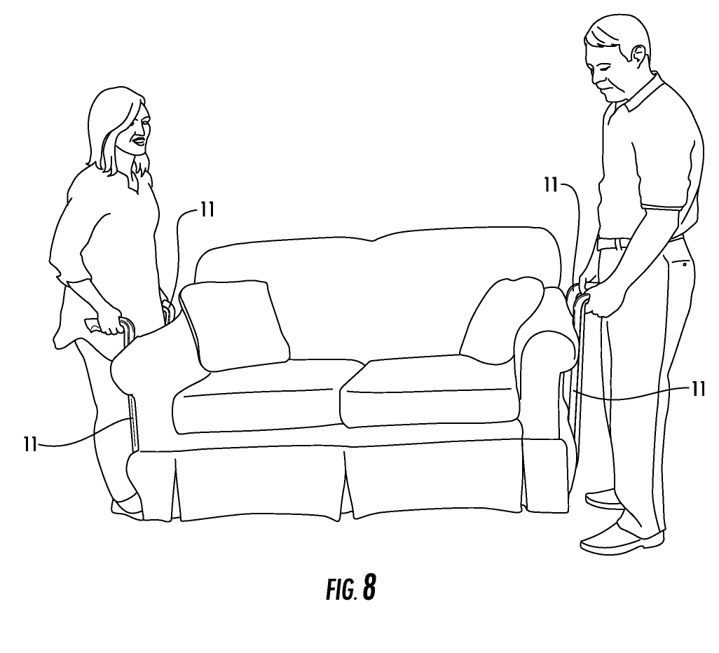

FIGS. 7 and 8 illustrate greater detail how the device may be used by two people. As illustrated in FIG. 7, the lifting device 11 is placed adjacent to an object to be lifted with the “foot” made up of the extension 13 and sleeve 17 projecting underneath the device. As may be appreciated, for more stability, the extension 13 while projecting generally horizontally is preferably constructed to project slightly above horizontal, typically about 10° to about 20° above a horizontal line from the main portion or rod of the device 11. As illustrated in FIG. 8, the support extension 13 is sufficiently long to accommodate, for example the roll arms of a large sofa so that it is able to project under the sofa. FIG. 8 illustrates how two individuals can use the device of the invention to easily move a sofa without placing substantial amounts of strain on a user's back. The device 11 is of a length such that the handle is at a person's mid-thigh or slightly below when in use.

In one preferred embodiment, the invention is a kit comprised of two of the lifting devices 11. In a more specific embodiment for lifting large objects such as sofas, the kit may involve four of the devices along with a set of instructions for use in the manner illustrated in FIGS. 7 and 8.

While the present invention has been illustrated by a description of various embodiments and while these embodiments have been described in considerable detail, it is not the intention of the applicant to restrict or in any way limit the scope of the appended claims to such detail. The invention in its broader aspects is therefore not limited to the specific details, representative apparatus and method, and the illustrative examples shown and described. Accordingly, departures may be made from such details without departing from the spirit or scope of applicant's general inventive concept.

What is claimed is:

1. A furniture lifting device, comprising:
a vertically extending rod;
a support extension extending substantially horizontally from the rod at one end for being received under furniture to be moved to provide a lifting base; and
a handle at another end of the rod extending substantially horizontally from the rod in a direction opposite the direction of the support extension.

2. The lifting device of claim 1, wherein said support extension extends at an upward angle of about 10° to about 20° from horizontal.

3. The lifting device of claim 1, wherein said rod, support extension and handle are unitary.

4. The lifting device of claim 1, wherein the device is made of glass filled polypropylene.

5. The lifting device of claim 1, wherein the support extension includes a sleeve cover made of thermoplastic polyurethane.

6. The lifting device of claim 1, further comprising a soft bumper on the rod in proximity to the handle at a location facing furniture, when in use, to protect the furniture in the event of contact.

7. The lifting device of claim 1, wherein the length of the device is such that the handle reaches to about slightly below a user's mid-thigh when in use.

8. The lifting device of claim 1, wherein the support extension is of sufficient length to extend under items to be lifted having an expanded upper dimension greater than the items dimension proximate the floor.

9. The lifting device of claim 1, wherein the handle has cutout regions to accommodate a user's fingers.

10. A kit for lifting and moving furniture, comprising at least two of the lifting device of claim 1.

11. A kit for lifting and moving furniture, comprising four of the lifting device of claim 1.
